(19) United States
(12) Patent Application Publication
(10) Pub. No.: US 2015/0205434 A1
(43) Pub. Date: Jul. 23, 2015

(54) INPUT CONTROL APPARATUS, INPUT CONTROL METHOD, AND STORAGE MEDIUM

(71) Applicant: CANON KABUSHIKI KAISHA, Tokyo (JP)

(72) Inventor: Tetsurou Kitashou, Tokyo (JP)

(21) Appl. No.: 14/599,332

(22) Filed: Jan. 16, 2015

(30) Foreign Application Priority Data
Jan. 20, 2014 (JP) 2014-008031

(51) Int. Cl. G06F 3/041

(52) U.S. Cl. CPC G06F 3/0416; G06F 2203/04104

(57) ABSTRACT

An input control apparatus includes a first acquisition unit configured to acquire first information representing an input position, on an input screen, of each of a plurality of input operations performed on the input screen at a corresponding timing, a second acquisition unit configured to acquire second information representing a position, on the input screen, of each of a plurality of objects displayed on the input screen, a determination unit configured to determine an operation area, on the input screen, corresponding to each of the objects based on the second information, and an association unit configured to associate the input operation with each of the objects based on the first information and the operation area.

### BACKGROUND

1. Technical Field

Exemplary embodiments described below relate to an input control apparatus, an input control method, and a storage medium.

2. Description of the Related Art

Conventionally, a technique for operating one large-sized touch screen display while sharing the touch screen display among a plurality of persons has been known. In such a technique, if it is erroneously recognized that different users perform continuous operations such as double click and cut and paste, for example, processing different from processing intended by a user may be performed. An information processing apparatus that controls a touch screen needs to specify which of the users has performed each of the operations.

A technique for managing an operation performed by each user includes a technique for independently forming an operable area for each user on a touch screen display. Japanese Patent Application Laid-Open No. 2006-65558 discusses a technique for forming and laying out an area on a touch screen display according to a user operation.

### SUMMARY

The embodiments of the present invention are directed to a technique capable of further improving convenience for a user when a touch screen display is shared among a plurality of persons.

According to an aspect of the embodiment of the present invention, an input control apparatus includes a first acquisition unit configured to acquire first information representing an input position, on an input screen, of each of a plurality of input operations performed on the input screen at a corresponding timing, a second acquisition unit configured to acquire second information representing a position, on the input screen, of each of a plurality of objects displayed on the input screen, a determination unit configured to determine an operation area, on the input screen, corresponding to each of the objects based on the second information, and an association unit configured to associate the input operation with each of the objects based on the first information and the operation area.

Further features of the present invention will become apparent from the following description of exemplary embodiments with reference to the attached drawings.

### BRIEF DESCRIPTION OF THE DRAWINGS

FIG. 1 is a block diagram illustrating an input control apparatus.

FIG. 2 is a block diagram illustrating the input control apparatus.

FIG. 3 illustrates an example of a data configuration of a content.

FIG. 4 illustrates an example of display of image data.

FIG. 5 is a flowchart illustrating area determination processing.

FIG. 6 illustrates an example of a data configuration of object information.

FIG. 7 illustrates an example of a data configuration of area information.

FIG. 8 illustrates an example of display of image data.

FIG. 9 is a flowchart illustrating input control processing.

FIG. 10 illustrates an example of a data configuration of input information.

FIG. 11 is a flowchart illustrating input information classification processing.

FIG. 12 illustrates an example of a data configuration of object-by-object input information.

FIG. 13 is a flowchart illustrating content updating processing.

### DESCRIPTION OF THE EMBODIMENTS

An exemplary embodiment of the present invention will be described below with reference to the drawings.

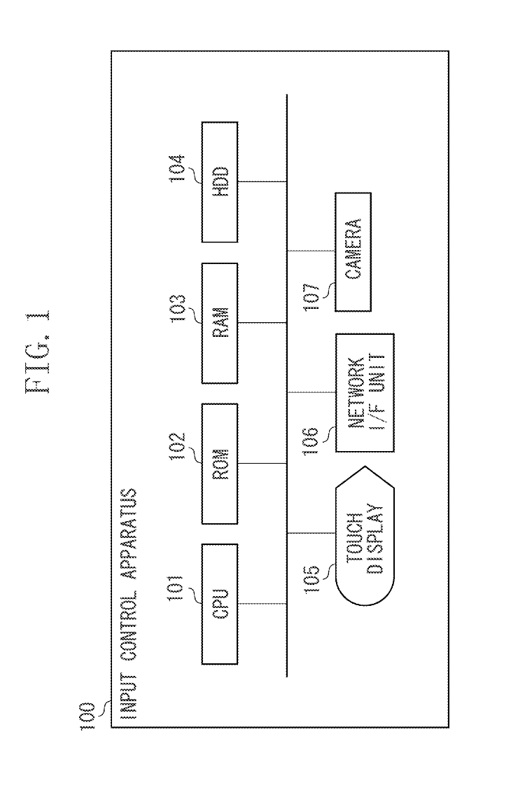

FIG. 1 illustrates a hardware configuration of an input control apparatus 100 according to an exemplary embodiment of the present invention. The input control apparatus 100 includes a central processing unit (CPU) 101, a read-only memory (ROM) 102, a random access memory (RAM) 103, a hard disk drive (HDD) 104, a touch display 105, a network interface (I/F) unit 106, and a camera 107. The CPU 101 reads out a control program stored in the ROM 102, to perform various types of processing. The RAM 103 is used as a temporary storage area such as a main memory or a work area of the CPU 101. The HDD 104 stores various types of information such as image data and various programs.

The touch display panel 105 has a display screen, and displays the various types of information. The touch display 105 also has an input screen, and detects a contact operation with a finger or a pen by a user. The touch display 105 in the input control apparatus 100 according to the present exemplary embodiment is a multi-touch input device, for example, and can detect, when a plurality of users has simultaneously performed inputs, each of the inputs. The touch display 105 detects, when a touch input has been performed, a position on the touch display 105 of the touch input, and sends position information representing the detected position to the CPU 101.

The camera 107 captures an image. The camera 107 according to the present exemplary embodiment captures an image in an imaging range including the touch display 105. Suppose that an object such as a mobile phone possessed by the user is placed on the touch display 105, for example. In this case, the camera 107 captures an image including the object and the touch display 105. The camera 107 may capture either one of a moving image and a still image. The network I/F unit 106 performs communication processing with an external apparatus wirelessly via a network. More specifically, the network I/F unit 106 performs short-range wireless communication using Near field communication (NFC).

A function and processing of the input control apparatus 100, described below, is implemented by the CPU 101 reading out a program stored in the ROM 102 or the HDD 104 and executing the program.

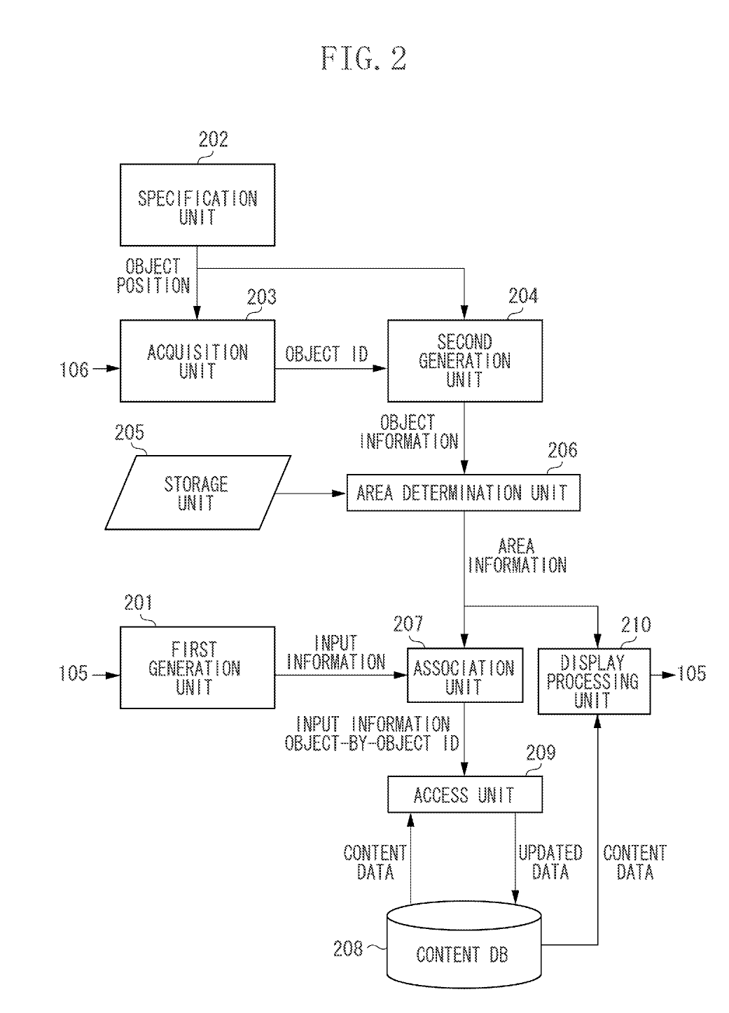

FIG. 2 is a block diagram illustrating a functional configuration of the input control apparatus 100. The input control apparatus 100 includes a first generation unit 201, a specification unit 202, an acquisition unit 203, a second generation unit 204, a storage unit 205, an area determination unit 206, and an association unit 207. The input control apparatus 100 further includes a content database (DB) 208, an access unit 209, and a display processing unit 210. Main processing of each of the units is described below. Detailed processing of each of the units will be described in detail thereafter.

The first generation unit 201 acquires, when the touch input has been detected on the touch display 105, information representing an input position (first information) from the touch display 105. The information representing an input position is information representing a position where an input operation has been performed on the touch display 105. The first generation unit 201 generates input information based on the input position.

The specification unit 202 specifies, when an object exists on the touch display 105, an object position. In the present exemplary embodiment, the object is a portable information processing apparatus capable of communicating with the network I/F 106. As another example, the object may be an object to which the portable information processing apparatus is attached. Information representing the object position is a position where the object is arranged on the touch display 105.

More specifically, the specification unit 202 specifies, based on an image in the vicinity of the touch display 105 obtained by the camera 107, a position in a real space of the object (three-dimensional position) from a position where the camera 107 is installed and a position of the object in the image. Regarding processing for specifying the three-dimensional position by the object position specification unit 202, U.S. patent application Publication Ser. No. 07/469,351, for example, can be referred to. Further, the specification unit 202 specifies a two-dimensional position on the touch display 105 of the object based on the specified position.

The object existing on the touch display 105 includes not only an object, which contacts the touch display 105, but also an object, which is positioned in a space on the touch display 105 while being held in a user's hand, for example. The specification unit 202 considers an object positioned within a reference range using a position of the touch display 105 as a reference as an object serving as a processing target, for example. The reference range is previously stored in the HDD 104, for example.

In the present exemplary embodiment, the object is an object such as a mobile phone placed on the touch display 105. However, the object is not limited to this. The object may be a specific content (e.g., an icon) displayed on the touch display 105.

The acquisition unit 203 acquires, based on the object position specified by the specification unit 202, an object identifier (ID) of the object positioned at the object position from the object via the network I/F unit 106. The second generation unit 204 generates a plurality of object information respectively corresponding to detected objects based on the object position specified by the specification unit 202 and the object ID acquired by the acquisition unit 203.

The storage unit 205 stores device information. The device information is information representing the size of a display area of the touch display 105. The area determination unit 206 specifies, based on the plurality of object information and the device information, operation areas of users who possess the objects respectively corresponding to the object information. The area determination unit 206 generates area information representing the operation area. The operation area is an area, to which each of the users can perform a touch operation, on the touch display 105. The area determination unit 206 further sets an access right of a content, described below, based on the specified operation area. The association unit 207 classifies the input information generated by the first generation unit 201 into input information for each object ID based on the area information. The association unit 207 performs processing for associating, based on information representing a position where an input operation has been performed on the input screen and the operation area, the input operation with the object.

The content DB 208 stores a content group including a plurality of contents. The content is data to be displayed on the touch display 105. The access unit 209 updates the content in the content DB 208 based on the input information for each object ID received from the association unit 207. The display processing unit 210 generates image data to be displayed on the touch display 105 based on the area information and the content, and displays the generated image data on the touch display 105.

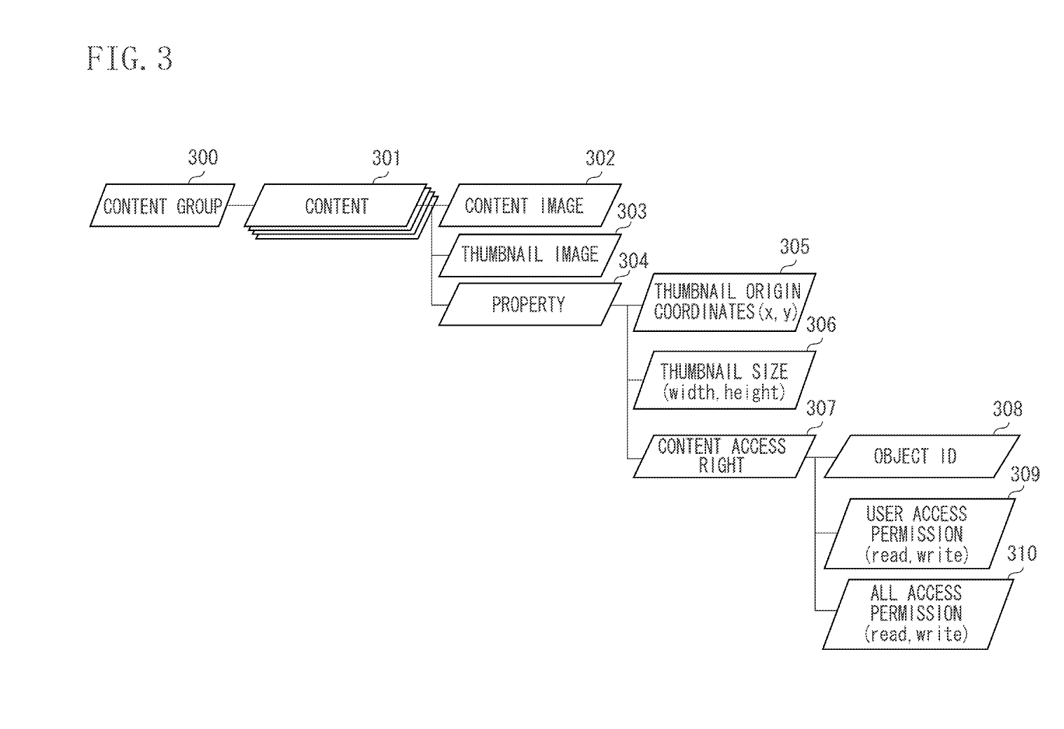

FIG. 3 illustrates an example of a data configuration of the content. A content group 300 includes a plurality of contents 301. Each of the contents 301 includes a content image 302, a thumbnail image 303, and a property 304. The content image 302 is graphic data and digital image data acquired by the camera 107. The thumbnail image 303 is image data obtained by reducing the size of the content image 302.

The property 304 includes thumbnail origin coordinates 305 and a thumbnail size 306 relating a display layout of the thumbnail image 303 and a content access right 307 relating to an access permission to the content 301. The thumbnail origin coordinates 305 are coordinate information representing a thumbnail display position on the touch display 105 when the thumbnail image 303 is displayed on the touch display 105. The thumbnail size 306 is information representing the size of the thumbnail image 303. The display processing unit 210 generates image data of the content 301 based on the thumbnail origin coordinates 305 and the thumbnail size 306 of the content 301.

The content access right 307 is set based on area information by the area determination unit 206. Information other than the content access right 307 in the content 301 is previously stored in the content DB 208.

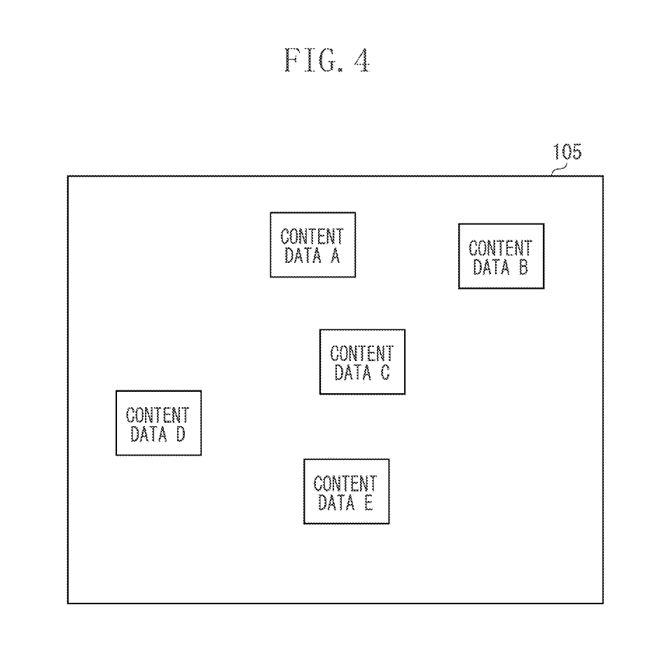

FIG. 4 illustrates an example of display of the image data generated by the display processing unit 210. In the example illustrated in FIG. 4, five contents, i.e., contents A to E are displayed on the touch display 105. The display processing unit 210 generates images of the contents A to E based on the thumbnail origin coordinates 305 and the thumbnail size 306 in the content 301 illustrated in FIG. 3, and generates image data including the images.

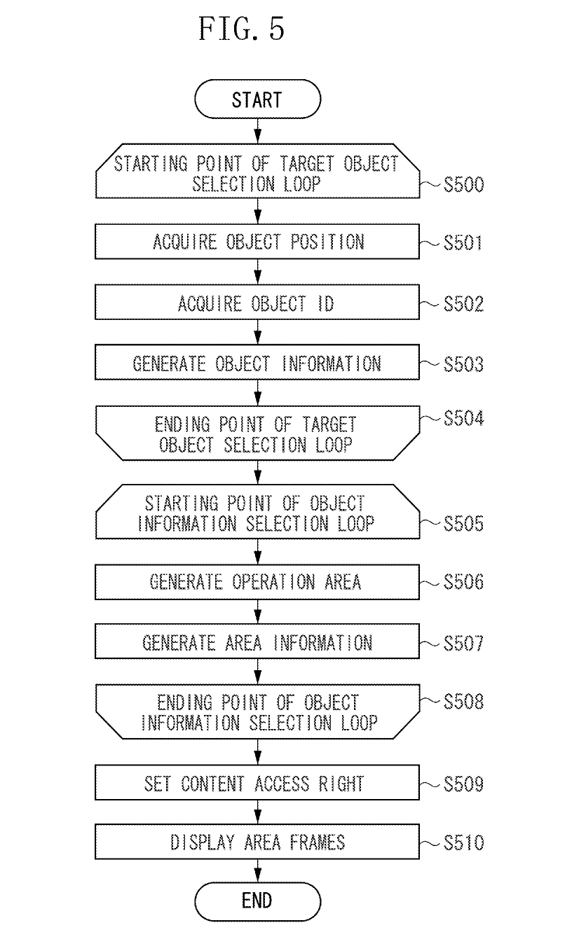

FIG. 5 is a flowchart illustrating area determination processing by the input control apparatus 100. The CPU 101 monitors the presence or absence of an object based on the image captured by the camera 107, and starts the area determination processing when the object is detected. In the present exemplary embodiment, the area determination processing will be described using a case where a plurality of objects respectively possessed by a plurality of users is placed on the touch display 105 as an example.

In step S500, the CPU 101 selects one of the detected objects as a processing target. Processes in steps S500 to S504 constitute loop processing. The CPU 101 repeats the processes in steps S500 to S504 until all the detected objects are selected as a processing target.

In step S501, the specification unit 202 then specifies an object position of the target object i.e., a processing target. The process in step S501 is an example of processing for acquiring an object position of an object existing on an input screen. In step S502, the acquisition unit 203 then acquires an object ID of the target object based on the object position.

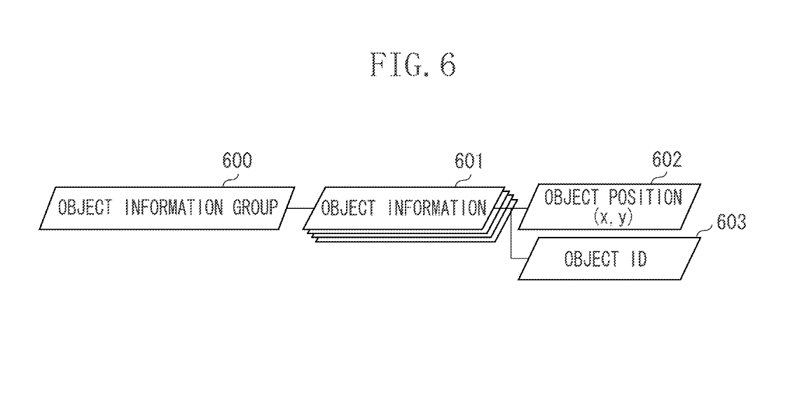

In step S503, the second generation unit 204 then generates object information of the target object based on the object position and the object ID. FIG. 6 illustrates an example of a data configuration of the object information. Object information 601 includes an object position 602 and an object ID 603. In step S504, the CPU 101 then confirms whether all the detected objects have been selected as the target object. If the object, which has not yet been selected, exists, the processing proceeds to step S500. In step S500, the CPU 101 continues processing for selecting the object, which has not yet been selected, as the target object, and generating object information. On the other hand, if all the objects have already been selected as the target object, the processing proceeds to step S505.

When the processes in step S500 to S504 are thus repeated, the second generation unit 204 generates the object information 601 that are the same in number as the objects existing on the touch display 105. Thus, an object information group 600 including the plurality of object information 601 is obtained, as illustrated in FIG. 6.

In step S505, the CPU 101 then selects the one object 601 from the object information group 600 illustrated in FIG. 6 as a processing target. Processes in steps S505 to S508 constitute loop processing. The CPU 101 repeats the processes S505 to S508 until all the pieces of the object information 601 included in the object information group 600 is selected.

In step S506, the area determination unit 206 then determines an operation area for each object (for each user) (area determination processing) based on the device information and the object information 601 generated in steps S500 to S503. More specifically, the area determination unit 206 determines a reference range using the object position 602 included in the target object information 601 of the processing target as a reference as an operation area of a user who possesses an object corresponding to the target object information 601. In the present exemplary embodiment, the reference range is a rectangular area with the object position as the center. Information relating to the reference range is previously stored in the HDD 104, for example. A shape of the operation area is not limited to that in the exemplary embodiment. As another example, the shape of the operation area may be a circle.

The area determination unit 206 further determines a plurality of exclusive operation areas so that an overlap does not occur among the operation areas in repetition processing in step S504, described below. Suppose that an operation area determined based on the reference range includes the operation area, which has already been generated in the loop processing in steps S505 to S508, for example. In this case, the area determination unit 206 adjusts two operation areas, which overlap each other, so that an intermediate point between object positions respectively corresponding to the two operation areas is a boundary position between the two operation areas.

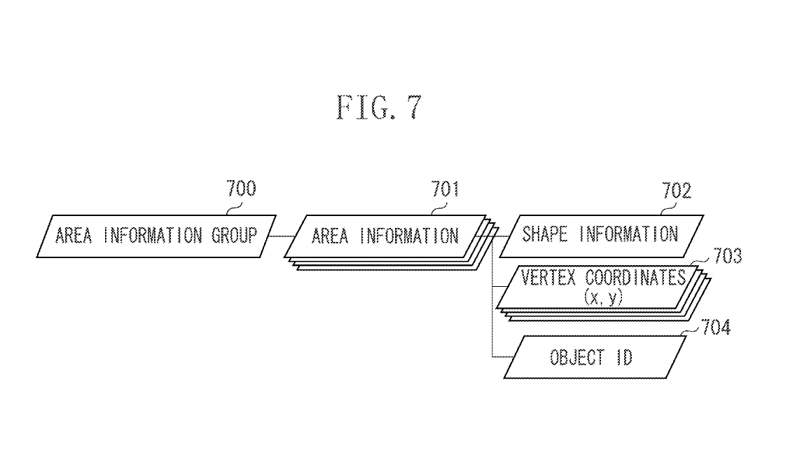

In step S507, the area determination unit 206 then generates area information representing the determined operation area. FIG. 7 illustrates an example of a data configuration of the area information. Area information 701 includes shape information 702, vertex coordinates 703, and an object ID 704. The shape information 702 is information representing a shape of an operation area. The shape information 702 in the present exemplary embodiment is information representing a rectangle. The vertex coordinates 703 are coordinate information of a vertex position for drawing the rectangle. The object ID 704 is an object ID of an object corresponding to the operation area.

The area determination unit 206 generates the shape information 702 based on information relating to the reference range stored in the HDD 104, and generates vertex coordinates of the operation area actually generated in step S506 as the vertex coordinate 703. The area determination unit 206 further copies the object ID 603 included in the object information 601 of a processing target onto the object ID 704.

Referring back to FIG. 5, in step S508, the CPU 101 confirms whether all the pieces of the object information 601 included in the object information group 600 have been selected. If the object information 601, which has not yet been selected, exists, the processing proceeds to step S505. In step S505, the CPU 101 continues processing for selecting the object information 601, which has not yet been selected, and generating area information. On the other hand, if all the pieces of the object information 601 have already been selected, the processing proceeds to step S509.

The processes in steps S505 to S508 are thus repeated so that the plurality of area information 701 corresponding to all the pieces of the object information 601 included in the object information group 600 are generated. Thus, an area information group 700 including the plurality of area information 701 is obtained, as illustrated in FIG. 7.

In step S509, the area determination unit 206 then sets the content access right 307 in each of the contents 301 in the content group 300 illustrated in FIG. 3. As illustrated in FIG. 3, the content access right 307 includes an object ID 308, a user access permission 309, and an all access permission 310. The area determination unit 206 sets an object ID of an object having the content access right 307 in the content 301 as the object ID 308.

More specifically, the area determination unit 206 sets the object ID 704 included in the area information 701 of the operation area including a thumbnail display area in the content 301 as the object ID 308. An object ID registered in the object ID 308 is hereinafter referred to as a registered object ID.

The user access permission 309 is information indicating whether the content 301 corresponding to the registered object ID set as the object ID 308 is readable therefrom and writable thereinto. In the present exemplary embodiment, both “readable” and “writable” are set in the user access permission 309.

The all access permission 310 is information indicating whether the content 301 corresponding to the object ID other than the registered object ID set as the object ID 308 is readable therefrom and writable thereinto. In the present exemplary embodiment, “readable” and “unwritable” are set in the all access permission 310.

More specifically, in a touch input corresponding to the registered object ID set as the object ID 308, the corresponding content 301 is permitted to be read out and written into. On the other hand, in a touch input corresponding to the object ID other than the registered object ID in the object ID 308, the corresponding content 301 is permitted to be read out but is inhibited from being written into.

The area determination unit 206 may set the object ID 308 based on a positional relationship between the thumbnail display area and the operation area. Specific processing is not limited to that in the present exemplary embodiment. As another example, the area determination unit 206 may set the object ID 704 as the object ID 308 when a part of the thumbnail display area is included in the operation area instead of the entire thumbnail display area being included in the operation area.

If the thumbnail display area overlaps a plurality of operation areas, the area determination unit 206 sets an object ID corresponding to the operation area that overlaps the thumbnail display area by the larger area as the object ID 308.

As another example of a case where the display area overlaps a plurality of operation areas, the area determination unit 206 may not set the object ID 704 corresponding to any one of the operation areas. A further example of the case where the display area overlaps a plurality of operation areas, the area determination unit 206 may permit an instruction, from the object ID corresponding to any one of the operation areas, to read the content 301 and inhibits an instruction from any one of the object IDs to write the content 301.

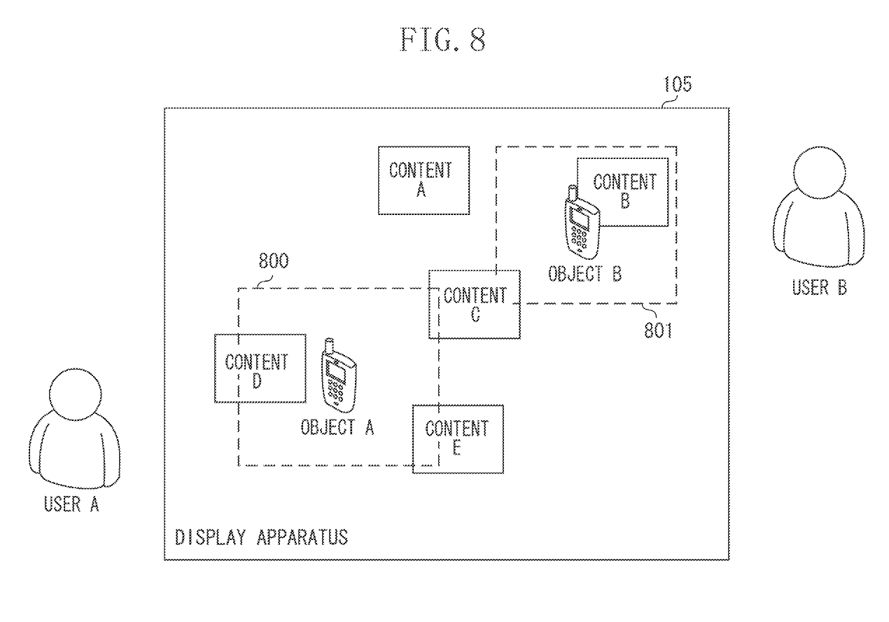

In step S510, the display processing unit 210 then generates image data based on the content group 300 and the area information group 700, and displays the generated image data on the touch display 105. FIG. 8 illustrates an example of display of the image data generated by the display processing unit 210. In the example of display illustrated in FIG. 8, two users A and B respectively place objects A and B possessed by themselves on the touch display 105.

Two area frames 800 and 801 are displayed on the touch display 105, respectively corresponding to the objects A and B. The area frames 800 and 801 are respectively boundary lines of operation areas specified by the area determination unit 206 using positions where the objects A and B are placed as references.

The display processing unit 210 displays the area frames 800 and 801 illustrated in FIG. 8 on the touch display 105 based on the pieces of area information 701 respectively generated for the different objects (objects A and B).

More specifically, the display processing unit 210 generates an image of the area frame 800 representing the operation area determined by the shape information 702 and the vertex coordinates 703 in the area information 701 corresponding to the object A. Similarly, the display processing unit 210 generates an image of the area frame 801 based on the shape information 702 and the vertex coordinates 703 in the area information 701 corresponding to the object B. The display processing unit 210 combines the images and images of contents, to generate image data.

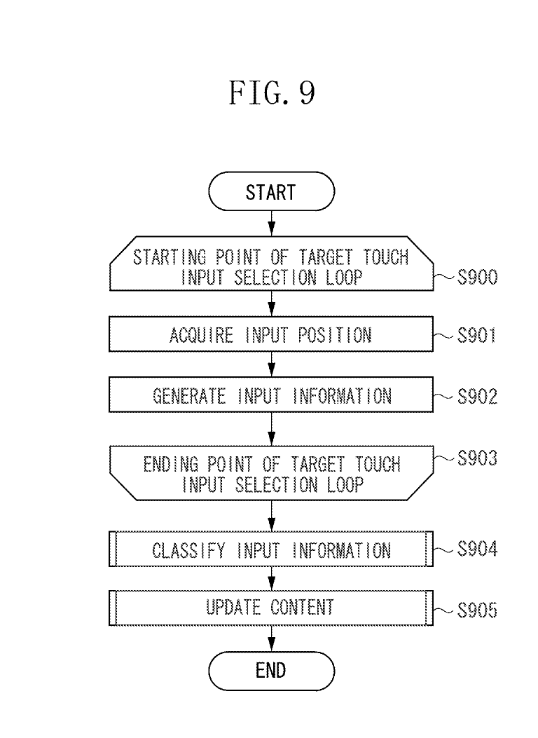

FIG. 9 is a flowchart illustrating input control processing by the input control apparatus 100. The CPU 101 monitors, based on a detection result of a touch input from the touch display 105, the presence or absence of the touch input, and starts the input control processing when the touch input is detected. In the present exemplary embodiment, a case where the plurality of users has simultaneously performed touch inputs on the touch display 105, i.e., a case where a plurality of touch inputs has simultaneously been performed will be described. In the present exemplary embodiment, the touch input is an instruction input relating to a layout change of a content.

In step S900, the CPU 101 selects one of a plurality of touch inputs as a processing target. Processes in steps S900 to S903 constitute loop processing. The CPU 101 repeats the processes S900 to S903 until all the detected touch inputs are selected as a processing target.

In step S901, the first generation unit 210 acquires an input position corresponding to the target touch input of a processing target (first acquisition processing) from the touch display 105. In step S902, the first generation unit 201 then generates input information corresponding to the target touch input.

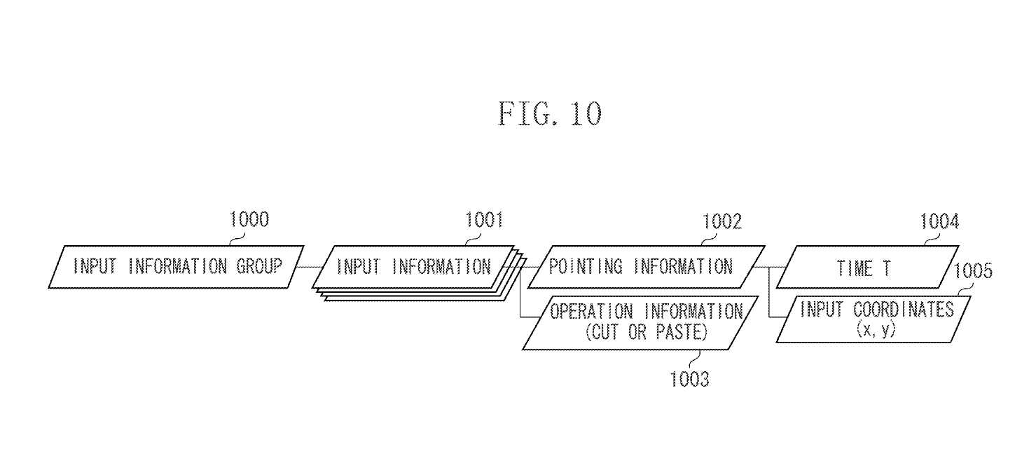

FIG. 10 illustrates an example of a data configuration of the input information. Input information 1001 includes pointing information 1002 and operation information 1003. The operation information 1003 is information representing the type of a touch input operation such as cut or paste. The pointing information 1002 includes a time 1004 and input coordinates 1005. The time 1004 is information representing the time when a touch input has been performed. The input coordinates 1005 are a coordinate value (x, y) of an input position on the touch display 105 of the touch input.

The first generation unit 201 generates information representing the time when the input position has been acquired from the touch display 105 as the time 1004, and generates the operation information 1003 based on the input position and a display content of the touch display 105, to generate input information.

Referring back to FIG. 9, in step S903, the CPU 101 confirms whether all the detected touch inputs have been selected as the target touch input. If the touch input, which has not yet been selected, exists, the processing proceeds to step S900. In step S900, the CPU 101 continues processing for selecting the touch input, which has not yet been selected, and generating input information. On the other hand, if all the touch inputs have already been selected, the processing proceeds to step S904. By the foregoing repetition processing, the plurality of input information 1001 respectively corresponding to the plurality of touch inputs is generated. Thus, the first generation unit 201 obtains an input information group 1000 including the plurality of input information 1001, as illustrated in FIG. 10.

In step S904, the association unit 207 classifies the input information 1001 included in the input information group 1000 into object-by-object input information (classification processing) based on area information.

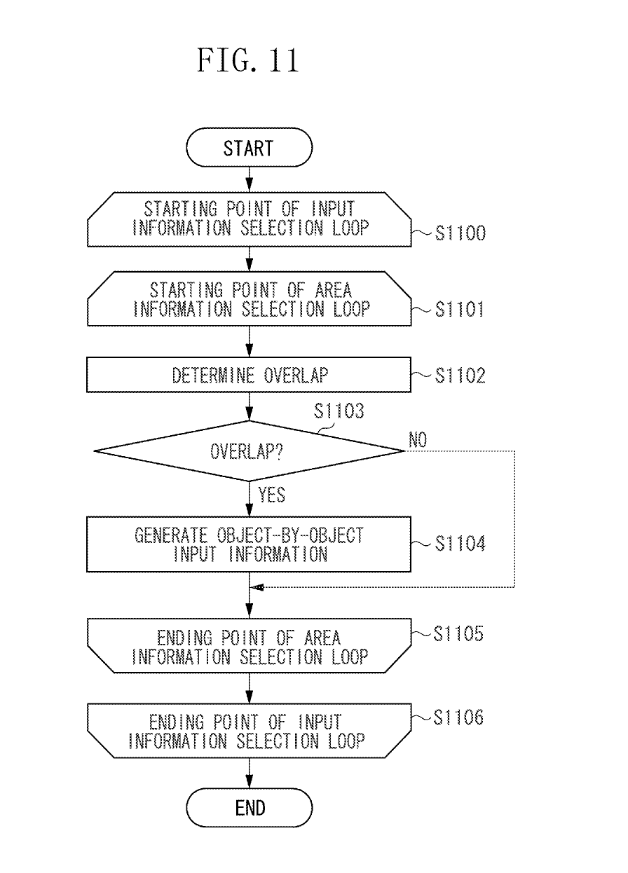

FIG. 11 is a flowchart illustrating detailed processing in the input information classification processing performed in step S904. In step S1100, the CPU 101 selects the one input information 1001 as target input information of a processing target from the input information group 1000 illustrated in FIG. 10. Processes in steps S1100 to S1106 constitute loop processing. The CPU 101 repeats the processes in steps S1100 to S1106 until all the pieces of the input information 1001 included in the input information group 1000 are selected as a processing target.

In step S1101, the CPU 101 then selects the one area information 701 from the area information group 700 illustrated in FIG. 7 as target area information of a processing target. The processes in steps S1101 to S1105 constitute loop processing. The CPU 101 repeats the processes S1101 to S1105 until all the pieces of the area information 701 included in the area information group 700 are selected as a processing target.

In step S1102, the association unit 207 then determines an overlap of a target touch input and a target operation area based on the target input information and the target area information. The target touch input is a touch input corresponding to the target input information. The target operation area is an operation area determined by the shape information 702 and the vertex coordinates 703 included in the target area information 701. In step S1103, the association unit 207 determines whether there is an overlap. More specifically, the association unit 207 determines whether the target touch input is included in the target operation area.

If the association unit 207 determines that there is an overlap (YES in step S1103), the processing proceeds to step S1104. If the association unit 207 determines that there is no overlap (NO in step S1103), the processing proceeds to step S1105.

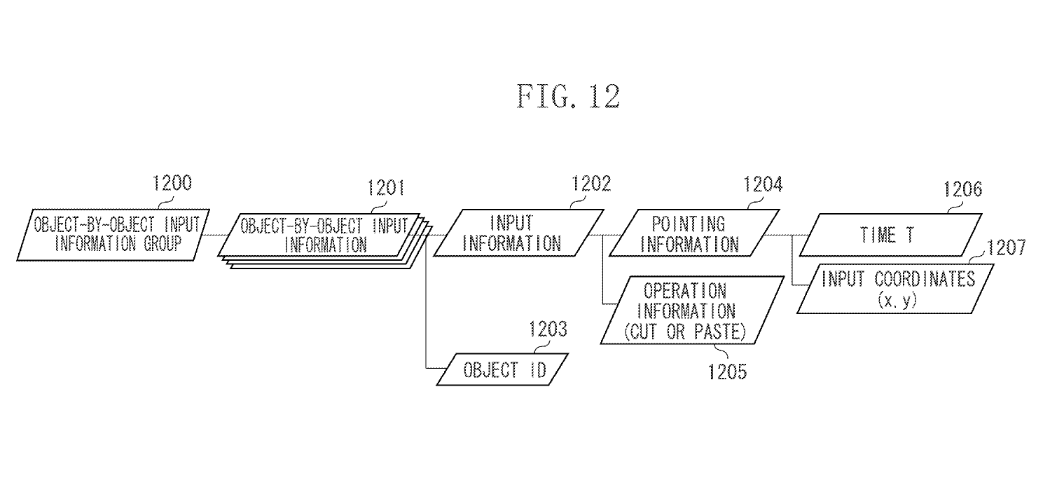

In step S1104, the association unit 207 assigns the object ID 704 included in the target area information 701 to the target input information, and generates object-by-object input information including the object ID 704 and the target input information. FIG. 12 illustrates an example of a data configuration of the object-by-object input information. Object-by-object input information 1201 includes input information 1202 and an object ID 1203. The input information 1202 is the same as the input information 1001. More specifically, the input information 1202 includes pointing information 1204, operation information 1205, a time 1206, and input coordinates 1207.

Referring back to FIG. 11, in step S1104, the association unit 207 generates the target input information (input information 1001) and the object ID 704 included in the target area information (area information 701), respectively, as the input information 1202 and the object ID 1203. Thus, the object-by-object input information 1201 is generated.

In step S1105, the CPU 101 then confirms whether all the pieces of the area information 701 included in the area information group 700 have been selected. If the area information 701, which has not yet been selected, exists, the processing proceeds to step S1101. In step S1101, the CPU 101 continues processing for selecting the area information 701, which has not yet been selected, and generating object-by-object input information. On the other hand, if all the pieces of the area information 701 has already been selected, the processing proceeds to step S1106.

In step S1106, the CPU 101 confirms whether all the pieces of the input information 1001 included in the input information group 1000 have been selected. If the input information 1001, which has not yet been selected, exists, the processing proceeds to step S1100. In step S1100, the CPU 101 continues processing for selecting the input information 1001, which has not yet been selected, and generating the object-by-object input information. On the other hand, if all the pieces of the input information 1001 has already been selected, the CPU 101 ends the input information classification processing in step S904, and the processing proceeds to step S905 illustrated in FIG. 9.

Through the foregoing repetition processing, a plurality of object-by-object input information 1201 is generated from the plurality of input information 1001 included in the input information group 1000 so that a object-by-object input information group 1200 including the plurality of object-by-object input information 1201 is obtained, as illustrated in FIG. 12.

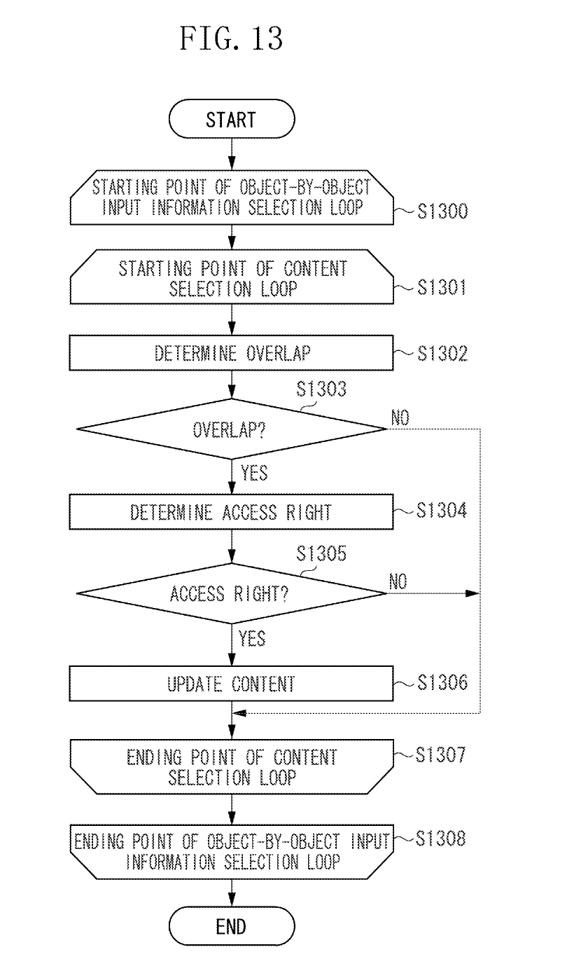

In step S905 illustrated in FIG. 9, the access unit 209 updates a content according to a layout change instruction received by the CPU 101 in response to the touch input. FIG. 13 is a flowchart illustrating detailed processing in content updating processing performed in step S905. In step S1300, the CPU 101 selects the one object-by-object input information 1201 from the object-by-object input information group 1200 as target object-by-object input information of a processing target. Processes in steps S1300 to S1308 constitute loop processing. The CPU 101 repeats the processes in steps S1300 to S1308 until all the pieces of the object-by-object input information 1201 included in the object-by-object input information group 1200 are selected as a processing target.

In step S1301, the CPU 101 then specifies the one content 301 as a target content of a processing target from the content group 300 illustrated in FIG. 3. The processes in steps S1301 to S1307 constitute loop processing. The CPU 101 repeats the processes in steps S1301 to S1307 until all the contents 301 included in the content group 300 are selected as a processing target.

In step S1302, the access unit 209 then determines an overlap of a target touch input and a target thumbnail based on the target object-by-object input information and the target content. The target touch input is a touch input corresponding to the target object-by-object input information. The target thumbnail is a thumbnail displayed on the touch display 105, corresponding to the target content.

In step S1303, the access unit 209 determines whether there is an overlap. More specifically, the access unit 209 refers to the input coordinates 1207 in the pointing information 1204 included in the target object-by-object input information 1201 and the thumbnail origin coordinates 305 and the thumbnail size 306 included in the target content 301. The access unit 209 determines whether the target touch input is included in a display area of the target thumbnail, i.e., whether the target touch input designates the target thumbnail.

If the access unit 209 determines that there is an overlap (YES in step S1303), the processing proceeds to step S1304. If the access unit 209 determines that there is no overlap (NO in step S1303), the processing proceeds to step S1307. In step S1304, the access unit 209 then determines an access right. More specifically, the access unit 209 determines whether the target content 301 corresponding to the object ID 1203 in the target object-by-object input information 1201 has been permitted to be accessed in the content access right 307 in the target content 301.

In step S1305, the access unit 209 determines whether there is an access right. If the access unit 209 determines that there is an access right (YES in step S1305), the processing proceeds to step S1306. If the access unit 209 determines that there is no access right (NO in step S1305), the processing proceeds to step S1307. In step S1306, the access unit 209 updates the content 301 based on the operation information 1205 in the target by-object input information 1201. In the present exemplary embodiment, the access unit 209 updates the thumbnail origin coordinates 305 in the content 301 according to the layout change instruction serving as the operation information 1205.

In step S1307, the CPU 101 confirms whether all the contents 301 included in the content group 300 have been selected. If the content 301, which has not yet been selected, exists, the processing proceeds to step S1301. In step S1301, the CPU 101 continues processing for selecting the content 301, which has not yet been selected, and updating a content property. On the other hand, if all the contents 301 have already been selected, the processing proceeds to step S1308.

In step S1308, the CPU 101 confirms whether all the pieces of the object-by-object input information 1201 included in the object-by-object input information group 1200 have been selected. If the object-by-object input information 1201, which has not yet been selected, exists, the processing proceeds to step S1300. In step S1300, the CPU 101 continues processing for selecting the object-by-object input information 1201, which has not yet been selected, and updating a content property. On the other hand, if all the pieces of the object-by-object input information 1201 has already been selected, the CPU 101 ends the content updating processing in step S905, and the input control processing illustrated in FIG. 9 ends.

Referring to FIG. 8, the input control processing will then be described in more detail. As illustrated in FIG. 8, if the area frames 800 and 801 are displayed, the input control apparatus 100 receives touch inputs to the area frames 800 and 801 as independent operations performed by the users A and B respectively corresponding to the objects A and B.

As described above, the input control apparatus 100 according to the present exemplary embodiment determines the plurality of operation areas respectively corresponding to the plurality objects, and classifies the input information based on a relationship between the input position and the operation area. More specifically, the input control apparatus 100 can automatically classify the touch inputs by the plurality of users respectively corresponding to the plurality of objects. Thus, the input control apparatus 100 can improve convenience when the plurality of users shares and operates the touch display 105.

As a first modification of the input control apparatus 100 according to the present exemplary embodiments, the area determination unit 206 may determine an operation area based on an orientation of an object in addition to or instead of an object position. For example, the area determination unit 206 may determine an area existing in a direction that a front surface of the object faces as an operation area. In this case, the CPU 101 specifies the orientation of the object based on an image obtained by the camera 107. Regarding the processing for specifying the orientation of the object, Japanese Patent Application Laid-Open No. 4-299467, for example, can be referred to.

As a second modification, the area determination unit 206 may determine the area of an operation area based on the type of an application running in an object. For example, the area determination unit 206 may determine a wider operation area for an object in which viewer software is running than for an object in which viewer software is not running. While the viewer software is running, more contents are expected to be referred to. As another example, the area determination unit 206 may determine a narrower operation area for an object in which editing software is running than for an object in which editing software is not running. While the editing software is running, contents are expected to be hardly referred to. In this case, the CPU 101 acquires information representing an application that is running (third information) in each of the objects via NFC by the network I/F unit 106 (third acquisition processing).

As a third modification, the area determination unit 206 may determine an operation area only when a distance between objects existing on the touch display 105 is a threshold value or smaller. The association unit 207 classifies input information only when the operation area has been determined, i.e., when the distance between the objects is the threshold value or smaller. The threshold value is previously stored in the HDD 104. Thus, only if touch inputs by a plurality of users is likely to be erroneously recognized as a series of operations, processing for classifying the input information can be performed.

As a fourth modification, the input control apparatus 100 may acquire an object position from an external apparatus (second acquisition processing). For example, in the external apparatus including a camera, an object position is specified, and the specified object position is transmitted to the input control apparatus 100.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-mentioned exemplary embodiments, convenience can be improved when the plurality of users shares and operates the touch display.

The invention is not limited to the above-mentioned exemplary embodiments. Various variations and modifications can be made without departing from the scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-008031 filed Jan. 20, 2014, which is hereby incorporated by reference herein in its entirety.

What is claimed is:

1. An input control apparatus comprising:
a first acquisition unit configured to acquire first information representing an input position, on an input screen, of each of a plurality of input operations performed on the input screen at a corresponding timing;
a second acquisition unit configured to acquire second information representing a position, on the input screen, of each of a plurality of objects displayed on the input screen;
a determination unit configured to determine an operation area, on the input screen, corresponding to each of the objects based on the second information; and
an association unit configured to associate the input operation with each of the objects based on the first information and the operation area.

2. The input control apparatus according to claim 1, further comprising an orientation specification unit configured to specify an orientation of each of the objects,
wherein the determination unit determines the operation area corresponding to each of the objects based on the orientation.

3. The input control apparatus according to claim 1, wherein each of the objects is an information processing apparatus, and further comprising
a third acquisition unit configured to acquire third information representing an application, which is running, in the information processing apparatus,
wherein the determination unit determines the operation area corresponding to each of the objects based on the third information.

4. The input control apparatus according to claim 1, wherein the determination unit determines the operation area in a case where a distance between the plurality of objects is a threshold value or smaller.

5. An input control method performed by an input control apparatus, comprising:
acquiring first information representing an input position on an input screen of each of a plurality of input operations performed on the input screen at a corresponding timing;
acquiring second information representing a position, on the input screen, of each of a plurality of objects displayed on the input screen;
determining an operation area on the input screen corresponding to each of the objects based on the second information; and
associating the input operation with each of the objects based on the first information and the operation area.

6. The input control method according to claim 5, further comprising specifying an orientation of each of the objects,
wherein in the determining, the operation area corresponding to each of the objects is determined based on the orientation.

7. The input control method according to claim 5, wherein each of the objects is an information processing apparatus, and further comprising
acquiring third information representing an application, which is running, in the information processing apparatus,
wherein, in the determining, the operation area corresponding to each of the objects is determined based on the third information.

8. The input control method according to claim 5, wherein in the determining, the operation area is determined in a case where a distance between the plurality of objects is a threshold value or smaller.

9. A storage medium storing a program for causing a computer to function as:
a first acquisition unit configured to acquire first information representing an input position, on an input screen, of each of a plurality of input operations performed on the input screen at a corresponding timing;
a second acquisition unit configured to acquire second information representing a position, on the input screen, of each of a plurality of objects displayed on the input screen;
a determination unit configured to determine an operation area, on the input screen, corresponding to each of the objects based on the second information; and
an association unit configured to associate the input operation with each of the objects based on the first information and the operation area.
